(19) United States
(12) Patent Application Publication
(10) Pub. No.: US 2004/0252563 A1
(43) Pub. Date: Dec. 16, 2004

(54) Magnetic record reproducing device

(75) Inventors: Shingo Hokuto, Kyoto (JP); Yujiro Okamoto, Kyoto (JP)

Correspondence Address: ARENT FOX PLLC, 1050 Connecticut Avenue, N.W., Suite 400, Washington, DC, 20036-5339, US

(73) Assignee: ROHM CO., LTD.

(21) Appl. No.: 10/859,575

(22) Filed: Jun. 3, 2004

(30) Foreign Application Priority Data
Jun. 12, 2003 (JP) 2003-167317

(51) Int. Cl. G11B 5/127

(52) U.S. Cl. 365/200

(57) ABSTRACT

The present invention provides a magnetic record reproducing device with a configuration that can decrease the fluctuation range of the current value caused by the dispersion of the resistance value of the magnetoresistive head itself. The magnetic record reproducing device is comprised of a transistor for inputting a bias voltage (V_{b-}), a transistor for inputting a bias voltage (V_{b+}) which is higher than V_{b-}, a magnetoresistive head 11 of which both ends are connected to the above transistors at the connection points P1 and P2, a constant current circuit which is connected to the connection point P1, a variable current circuit which is connected to the connection point P2, and a feedback circuit which controls the current of the variable current circuit according to the differential voltage (V₁, V₂) which is output by converting the current of the above transistors.

### BACKGROUND OF THE INVENTION

1. Field of the Invention

The present invention relates to a magnetic record reproducing device on which a magnetoresistive head is mounted.

2. Description of the Related Art

This type of magnetic record reproducing device, where the resistance value of the magnetoresistive head changes according to the magnetic field received from such a magnetic medium as a magnetic disk, converts the resistance value into voltage, amplifies the voltage, and outputs it. In other words, the magnetoresistive head reads the data recorded on the magnetic medium as a change of the resistance value, so it is preferable that the rate of change (MR ratio) of the resistance value is large. Recently as the density of magnetic media increases, a GMR (Giant Magnetoresistive) head was developed as a high sensitivity magnetoresistive head (reproducing head) of which the MR ratio is high, then a TMR (Tunneling Magnetoresistive) head was developed. At the moment 10% has been achieved as the MR ratio of a GMR head, and a higher MR ratio has been achieved for a TMR head. Also in the TMR head, the resistance of the head itself is high, about 200 to 400Ω, while it is about 30 to 80Ω in the case of the GMR head, so higher output can be obtained.

FIG. 10 shows a prior art of this type of magnetic record reproducing device. This is widely known as a magnetic record reproducing device using a GMR head or a TMR head, such as stated in U.S. Pat. No. 4,716,306.

This magnetic record reproducing device 101 is comprised of a magnetoresistance sense circuit 104 for outputting the differential voltage (V₁, V₂), a variable current circuit 107 to be a current source of the current (I₀) which flows through the magnetoresistance sense circuit 104, an amplifier for driving 110 for amplifying the output of the magnetoresistance sense circuit 104 and for driving subsequent circuits, and a feedback circuit 106 for controlling the current that flows through the variable current circuit 107 according to the differential voltage (V₁, V₂).

The magnetoresistance sense circuit 104 is further comprised of a magnetoresistive head 111, transistors 112 and 113 of which the respective emitters are connected to both ends of the magnetoresistive head 111 at the connection points P1 and P2, and of which bases the differential bias voltage (V_{b-}, V_{b+}), which is constant, is applied, and load resistors 120 and 121 which are connected to the respective collectors of the transistors 112 and 113, and of which the other end is connected to the power supply voltage (PS₊) at the positive side. The voltage generated in these load resistors 120 and 121 becomes the output voltage of the magnetoresistance sense circuit 104, that is the differential voltage (V₁, V₂).

The variable current circuit 107 is further comprised of the transistor 115 and a resistor 119 of which one end is connected to the emitter of the transistor 115, and the other end is connected to the power supply voltage (PS_{——}) at the negative side. The collector of the transistor 115 is connected to the connection point P1 of the magnetoresistance sense circuit 4.

The feedback circuit 106 is further comprised of an amplifier (gm amplifier) 122 which inputs the differential voltage (V₁, V₂) that is output by the magnetoresistance sense circuit 104 and outputs the current accordingly, and a capacitor 123 which stores the charges of current that the gm amplifier 122 outputs, and is connected to the base of the transistor 115 of the variable current circuit 107.

This magnetic record reproducing device operates as follows. In a stationary status where the magnetic field from the magnetic recording medium does not change, as mentioned later, the dropped voltages by the load resistor 121 and the load resistor 120 are the same, so the gm amplifier 122 does not draw or supply the stored charges of the capacitor 123. At this time, a constant voltage is output from the amplifier for driving 110.

When the magnetic field from the magnetic recording medium changes and the resistance value (R_{MR}) of the magnetoresistive head 111 drops, the current (I₂) that flows through the transistor 113 temporarily increases and the current (I₁) that flows through the transistor 112 decreases. As a result, the dropped voltage by the load resistor 121 becomes higher than the dropped voltage by the load resistor 120, so the gm amplifier 122 outputs current in a direction to supply the stored charges of the capacitor 123. At the same time, negative differential voltage is temporarily output from the amplifier for driving 110.

And when the stored charges of the capacitor 123 increases and the voltage thereof increases, the voltage to be applied to the resistor 119 also increases. Therefore the current (I₀) that flows through the resistor 119 and the transistor 115 increases, and the current (I₁) that flows through the transistor 112 also increases. As a result, the current that flows through the magnetoresistive head 111, that is the current (I₂) that flows through the transistor 113, and the current (I₁) that flows through the transistor 112 become equal, and the magnetic record reproducing device 101 stabilizes and enters a stationary status.

When the magnetic field from the magnetic recording medium changes and the resistance value (R_{MR}) of the magnetoresistive head 111 increases, an operation opposite from the above is performed and the positive differential voltage is temporarily output from the amplifier for driving 110.

Now it is assumed that V_{b}−(ΔV_{b})/2 and V_{b}+(ΔV_{b})/2 are applied to the respective base of the transistors 112 and 113 as the bias voltage (V_{b-}, V_{b+}). In the stationary status, the emitter-base voltages of the transistors 113 and 112 become equal so as to equalize the current (I₂) that flows through the transistor 113 and the current (I₁) that flows through the transistor 112. Therefore the voltage ΔV_{b} is applied on both ends of the magnetoresistive head 111.

In the magnetoresistive head 111, the current (I₂) that flows through the transistor 113 flows, so, the following formula is established.

I₁=I₂=(ΔV_{b})/R_{MR} (1)

### SUMMARY OF THE INVENTION

When the magnetoresistive head is a TMR head, the resistance value (RMR) of the head itself is about 200 to 400Ω, as mentioned above, and this is higher than that of the GMR head, which is about 30 to 80Ω. This makes high output possible for the TMR head, but high voltage cannot be applied because this causes damage.

So when a TMR head is used, the upper limit of the differential voltage (ΔV_{b}) of the above-mentioned bias voltage must be set to about 0.3V. The lower limit of the voltage ΔV_{b} requires at least 0.05V to obtain appropriate read characteristics.

The resistance value (R_{MR}) of the TMR head itself is about 200 to 400Ω, while this is about 30 to 80Ω in the case of the GMR head, and this large dispersion is supposed to come from manufacturing problems.

When these values are applied to the above formula (1), the maximum values of I₁ and I₂ are 1.5 mA when ΔV_{b} is 0.3V and R_{MR} is 200Ω. The minimum values of I₁ and I₂ are 125 μA when ΔV_{b} is 0.05V and R_{MR} is 400Ω. Therefore the difference between the maximum value and the minimum value is 12 times the minimum value.

For a magnetic record reproducing device, on the other hand, frequency characteristics which allow high-speed operation, a decrease in noise generated by transistors, and low power consumption are demanded. Generally high-speed is implemented if current that flows through the transistors is increased, but this runs counter to the requirement of low power consumption. A decrease in noise is not implemented by increasing or decreasing the current that flows through the transistors, but the optimum value thereof is determined by simulation.

Since the current value fluctuation of the magnetoresistance sense circuit, that is, the difference between the maximum value and the minimum value of I₁ and I₂ is 12 times the minimum value, as mentioned above, it is difficult to implement a magnetic record reproducing device with a circuit configuration that implements the above-mentioned requirements in this wide range.

With the foregoing in view, it is an object of the present invention to provide a magnetic record reproducing device with a circuit configuration which can decrease the current value fluctuation of the magnetoresistance sense circuit.

To solve the above problem, a magnetic record reproducing device according to the present invention comprises: a magnetoresistance sense circuit that further comprises a first transistor for inputting a first bias voltage, a second transistor which is connected in parallel with the first transistor and inputs a second bias voltage higher than the first bias voltage, and a magnetoresistive head of which both ends are connected to the first and second transistors, and that converts the current of the first and second transistors, which change according to the change of the resistance value of the magnetoresistive head, and outputs the differential voltage as the converted current; a constant current circuit that is connected to a connection point of the first transistor and the magnetoresistive head; a variable current circuit that is connected to a connection point of the second transistor of the magnetoresistive head; and a feedback circuit for controlling the current of the variable current circuit according to the differential voltage that is output from the magnetoresistance sense circuit.

Another magnetic record reproducing device according to the present invention comprises: a magnetoresistance sense circuit that further comprises a first transistor for inputting a first bias voltage, a second transistor which is connected in parallel with the first transistor and inputs a second bias voltage higher than the first bias voltage, and a magnetoresistive head of which both ends are connected to the first and second transistors, and that converts the current of the first and second transistors, which changes according to the change of the resistance value of the magnetoresistive head, and outputs the differential voltage as the converted current; a first and second constant current circuits that are connected to the connection points of the first and second transistors and the magnetoresistive head; and a feedback circuit for controlling the current of the first or second transistor according to the differential voltage that is output from the magnetoresistance sense circuit.

Still another magnetic record reproducing device according to the present invention comprises: a magnetoresistance sense circuit, that further comprises a first transistor for inputting a first bias voltage, a second transistor which is connected in parallel with the first transistor and inputs a second bias voltage higher than the first bias voltage, and a magnetoresistive head of which both ends are connected to the first and second transistors, and that converts the current of the first and second transistors, which changes according to the change of the resistance value of the magnetoresistive head, and outputs the differential voltage as the converted current; a variable current circuit that is connected to the connection points of the first and second transistors and the magnetoresistive head; and a feedback circuit for controlling the current of the variable current circuit by comparing the differential voltage that is output from the magnetoresistance sense circuit with a reference voltage.

In these magnetic record reproducing devices according to the present invention, frequency characteristics which allow high-speed operation, a decrease in the noise generated by transistors, and low power consumption can be implemented by decreasing the fluctuation range of the current value that flows in the first and second transistors connected to the magnetoresistive head.

### BRIEF DESCRIPTION OF THE DRAWINGS

FIG. 1 is a circuit diagram of a magnetic record reproducing device according to the first embodiment;

FIG. 2 is a circuit diagram of a magnetic record reproducing device according to the second embodiment;

FIG. 3 is a circuit diagram of a magnetic record reproducing device according to the third embodiment;

FIG. 4 is a circuit diagram of a magnetic record reproducing device according to the fourth embodiment;

FIG. 5 is a circuit diagram of a magnetic record reproducing device according to the fifth embodiment;

FIG. 6 is another circuit diagram of a feedback circuit in the magnetic record reproducing device according to the second and third embodiments;

FIG. 7 is another circuit diagram of a feedback circuit in the magnetic record reproducing device according to the fourth and fifth embodiments;

FIG. 8 is a circuit diagram of a magnetic record reproducing device according to the sixth embodiment;

FIG. 9 is a circuit diagram of a magnetic record reproducing device according to the seventh embodiment; and

FIG. 10 is a circuit diagram of a magnetic record reproducing device according to a prior art.

### DESCRIPTION OF THE PREFERRED EMBODIMENTS

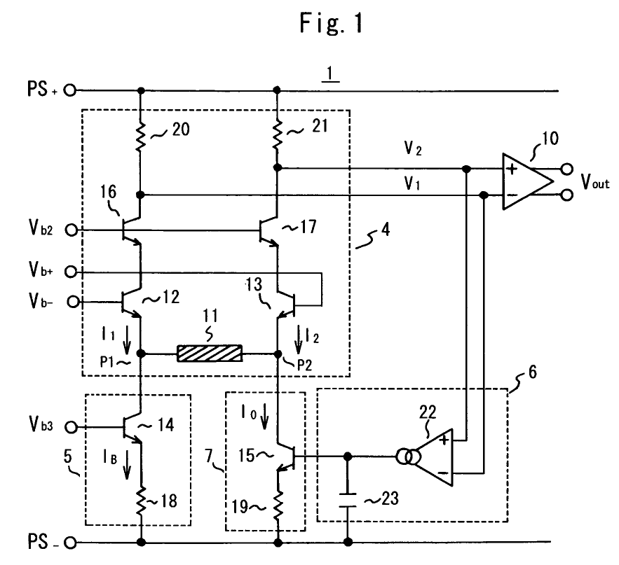

Embodiments of the present invention will now be described with reference to the drawings. FIG. 1 is a circuit diagram of a magnetic record reproducing device according to the first embodiment of the present invention.

This magnetic record reproducing device 1 is for detecting the change of the resistance value of the magnetoresistive head 11, and comprises the following circuits as major circuits. In other words, the magnetic record reproducing device 1 is comprised of a magnetoresistance sense circuit 4, a constant current circuit 5 and a variable current circuit 7 to be the current sources of the current (I_{B}, I₀) led from the magnetoresistance sense circuit 4, and an amplifier for driving 10 for amplifying the differential voltage (V₁, V₂), which is output from the magnetoresistance sense circuit 4, and for driving subsequent circuits, and a feedback circuit 6 for controlling the current that flows through the variable current circuit 7 according to the differential voltage (V₁, V₂).

The magnetoresistance sense circuit 4 is comprised of an NPN type first transistor 12 for inputting a first bias voltage (V_{b-}), an NPN type second transistor 13 that is connected in parallel with the first transistor 12 and inputs a second bias voltage (V_{b+}) higher than the first bias voltage, a magnetoresistive head 11 of which both ends are connected between the emitters of both transistors 12 and 13, that is, the connection points P1 and P2, NPN type third and fourth transistors 16 and 17 of which the emitters are connected to the collectors of the transistors 12 and 13, and of which bases a common bias voltage (V_{b2}) is applied, and load resistors 20 and 21 which are connected to the respective collectors of these transistors 16 and 17 and of which the other ends are connected to the power supply voltage (PS₊) at the positive side. This magnetoresistance sense circuit 4 converts the current of the first and second transistors, which changes according to the change of the resistance value of the magnetoresistive head 11, into voltage at the load resistors 20 and 21, and outputs this voltage as the differential voltage (V₁, V₂).

The constant current circuit 5 is comprised of an NPN type transistor 14 of which base the bias voltage (V_{b3}) is applied to, and a resistor 18 which is connected to the emitter of the transistor 14 and of which the other end is connected to the power supply voltage (PS₋) at the negative side. The collector of the transistor 14 is connected to the connection point P1 of the magnetoresistance sense circuit 4, that is the connection point between the emitter of the first transistor 12 and the magnetoresistive head 11.

The variable current circuit 7 is comprised of an NPN type transistor 15 and a resistor 19 which is connected to the emitter of the transistor 15 and of which the other end is connected to the power supply voltage (PS₋) at the negative side. The collector of the transistor 15 is connected to the connection point P2 of the magnetoresistance sense circuit 4, that is the connection point of the emitter of the second transistor 13 and the magnetoresistive head 11.

The feedback circuit 6 is comprised of a gm amplifier 22 for inputting one of the differential voltage V₁, which is output by the magnetoresistance sense circuit 4, to an inversion input terminal and inputting the other of the differential voltage V₂ to a non-inversion input terminal, and a capacitor 23 which stores electric charges of the current that is output by the gm amplifier 22 and which is connected to the base of the transistor 15 of the variable current circuit 7. This feedback circuit 6 controls the current of the variable current circuit 7 according to the differential voltage (V₁, V₂) that is output from the magnetoresistance sense circuit 4.

This magnetic record reproducing device 1 operates as follows. At first, in a stable status where the magnetic field from the magnetic recording medium does not change, the voltage drop by the load resistor 21 and that by the load resistor 20 are equal, and the gm amplifier 22 does not draw or supply the stored charge of the capacitor 23. At this time, a constant voltage is output from the amplifier for driving 10.

When the magnetic field from the magnetic recording medium changes and the resistance value (R_{MR}) of the magnetoresistive head 11 drops, the current (I₂) that flows through the second transistor 13 temporarily increases, and the current (I₁) that flows through the first transistor 12 decreases. As a result, the voltage dropped by the load resistor 21 becomes higher than the voltage dropped by the load resistor 20, so the gm amplifier 22 outputs current in the direction of drawing out the stored charges of the capacitor 23. At this time, negative differential voltage is temporarily output from the amplifier for driving 10.

And when the stored charges of the capacitor 23 decreases and the voltage thereof decreases, the voltage applied to the resistor 19 also decreases. Therefore, the current (I₀) that flows through the resistor 19 and the transistor 15 decreases, and the current (I₂) that flows through the second transistor 13 decreases. As a result, the current (I₂) that flows through the second transistor 13 and the current (I₁) that flows through the first transistor 12 become equal, and the magnetic record reproducing device 1 enters a stationary status.

When the magnetic field from the magnetic recording medium changes and the resistance value (R_{MR}) of the magnetoresistive head 11 rises, an operation opposite from the above is performed, and positive differential voltage is temporarily output from the amplifier for driving 10.

The operation of this magnetic record reproducing device 1 was described above, but in this magnetic record reproducing device 1, current is drawn at both sides of the magnetoresistive head 11, so the current value fluctuation of the magnetoresistance sense circuit 4 can be decreased. The specific calculation will be described below.

Now it is assumed that V_{b1}−(ΔV_{b1})/2, and V_{b1}+(ΔV_{b1})/2 are applied to each base of the first and second transistors 12 and 13 as a bias voltage (V_{b-}, V_{b+}). In a stationary status, these emitter-base voltages are the same in order that so the current (I₂) that flows through the second transistor 13 and the current (I₁) that flows through the first transistor 12 become equal. Therefore the voltage ΔV_{b1} is applied on both ends of the magnetoresistive head 11.

In a stationary status, the following formulas are established.

I₁=I_{B}−(ΔV_{b1})/R_{MR} (2)

I₂=I₀+(ΔV_{b1})/R_{MR} (3)

I₁=I₂ (4)

Therefore I₀=I_{B}−2×(ΔV_{b1})/R_{MR} (5)

So I_{B} must be set under the following conditions. That is,

I_{B}≧2×(ΔV_{b1})/R_{MR} (6)

When ΔV_{b1} is 0.3V and R_{MR} is 200Ω, I_{B} must be 3 mA or more according to formula (6). If I_{B} is set to 5 mA, I₁ and I₂ become 3.5 mA according to formulas (2) and (4), and this becomes the minimum value of I₁ and I₂. When ΔV_{b1} is 0.05V and R_{MR} is 400Ω, I₁ and I₂ become 4.875 mA according to formulas (2) and (4), and this becomes the maximum value of I₁ and I₂.

This means that the current value fluctuation of the magnetoresistance sense circuit, that is, the difference between the maximum value and the minimum value of I₁ and I₂, becomes a small value, 1.4 times. Since the current value fluctuation of the magnetoresistance sense circuit can be decreased in this way, improved effects can be obtained. Namely, a preferred magnetic record reproducing device which meets such requirements as frequency characteristics that allow high-speed operation, a decrease in the noise generated by transistors, and low power consumption can be implemented.

The third and fourth transistors 16 and 17 are for separating the output voltage by the load resistors 20 and 21 from the first and second transistors 12 and 13, so as to remove influences thereof, such as parasitic capacitance. It is because the first and second transistors 12 and 13 must be large sized to decrease noise and, therefore, parasitic capacitance is large. The third and fourth transistors 16 and 17 are effective for increasing the speed of the magnetic record reproducing device, but may be omitted if speed can be increased by another means (e.g. increasing current).

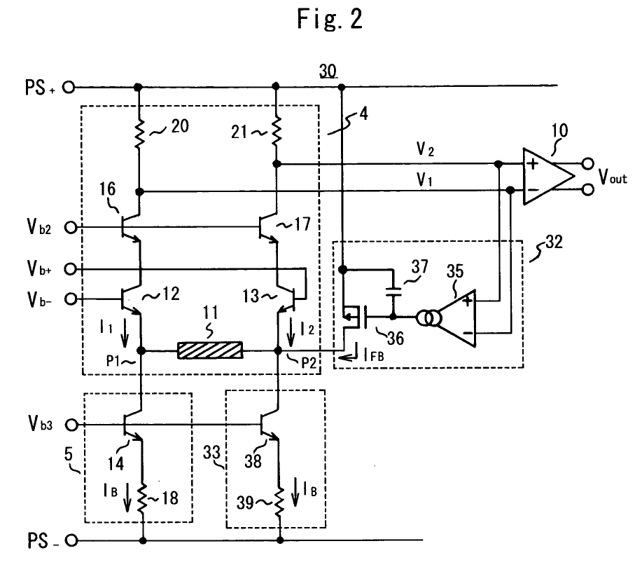

Now the magnetic record reproducing device according to the second embodiment of the present invention will be described with reference to FIG. 2. This magnetic record reproducing device 30 is comprised of a magnetoresistance sense circuit 4, a constant current circuit (first constant current circuit) 5, another constant current circuit (second constant current circuit) 33 that flows the same constant current (I_{B}) as the constant current circuit 5, an amplifier for driving 10, and a feedback circuit 32 for controlling the current that flows through the connection point P2 of the magnetoresistance sense circuit 4. The magnetoresistance sense circuit 4, the first constant current circuit 5 and the amplifier for driving 10 are the same as those in the first embodiment.

Just like the first constant current circuit 5, the second constant current circuit 33 is comprised of a transistor and a resistor (an NPN type transistor 38 and a resistor 39), and the base voltage (V_{b3}) of the transistor 38 is the same as the transistor 14 of the first constant current circuit 5. The collector of the transistor 38 is connected to the connection point P2 of the magnetoresistance sense circuit 4, which is the connection point of the emitter of the second transmitter 13 and the magnetoresistive head 11.

The feedback circuit 32 is comprised of a gm amplifier 35 for inputting one of the differential voltage V₁, which is output by the magnetoresistance sense circuit 4, to an inversion input terminal, and inputting V₂ to a non-inversion input terminal, and a capacitor 37 and a PMOS transistor 36 which are connected to the output of the gm amplifier 35. The drain of the PMOS transistor 36 is connected to the connection point P2 of the magnetoresistance sense circuit 4. This feedback circuit 32 controls the current (I_{FB}) that flows through the PMOS transistor 36 by adjusting the stored charges of the capacitor 37 according to the differential voltage (V₁, V₂) that is output by the magnetoresistance sense circuit 4, and thereby the current (I₂) of the second transistor 13 is controlled.

Since the magnetic record reproducing device generates a signal when the magnetic field from the magnetic recording medium changes, a low cut-off frequency exists in the frequency characteristics thereof. In the feedback circuit 32 of the present embodiment, the voltage-current conversion ratio of the gm amplifier 35 is decreased to minimize the low cut-off frequency, and the MOS type transistor 36 is used as the receiving side of the output of the gm amplifier 35, which is advantageous for the amount of base current. In the later mentioned other embodiments as well, an MOS type transistor is used for the output stage of the feedback circuit for the same reason.

Now it is assumed that V_{b1}−(ΔV_{b1})/2 and V_{b1}+(ΔV_{b1})/2 are applied as a bias voltage (V_{b1}, V_{b+}), and the voltage ΔV_{b1} is applied to both ends of the magnetoresistive head 11.

In a stationary status, the following formulas are established.

I_{B}=I₁+(ΔV_{b1})/R_{MR} (7)

I_{B}=I₂−(ΔV_{b1})/R_{MR}+I_{FB} (8)

I₁=I₂ (9)

Therefore

I_{FB}=2×(ΔV_{b1})/R_{MR} (10)

I₁=I₂=I_{B}−(ΔV_{b1})/R_{MR} (11)

So I_{B} must be set under the following conditions. That is,

I_{B}≧(ΔV_{b1})/R_{MR} (12)

When ΔV_{b1} is 0.3V and R_{MR} is 200Ω, I_{B} must be 1.5 mA or more according to formula (7). If I_{B} is set to 5 mA, I₁ and I₂ become 3.5 mA according to formula (11). When ΔV_{b1} is 0.05V and R_{MR} is 400Ω, I₁ and I₂ become 4.875 mA according to formula (11). This means that the difference between the maximum value and the minimum value is 1.4 times, that is, a similar effect as the magnetic record reproducing device according to the first embodiment can be obtained.

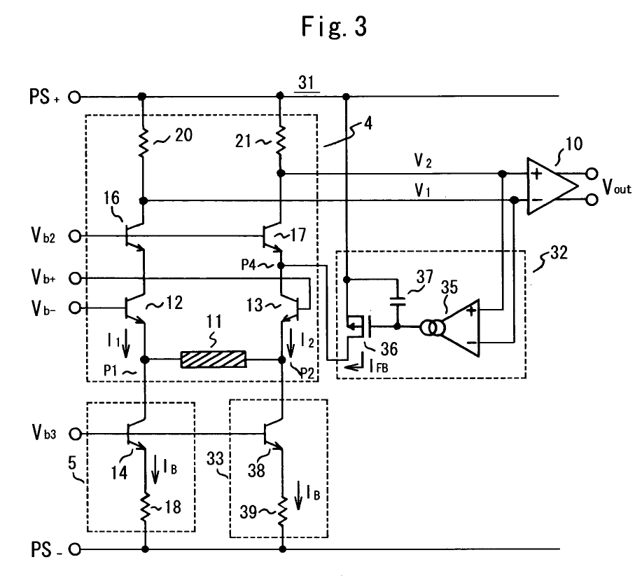

Now the magnetic record reproducing device according to the third embodiment of the present invention will be described with reference to FIG. 3. In this magnetic record reproducing device 31, the output of the feedback circuit 32 of the magnetic record reproducing device 30 of the second embodiment is connected to the connection point of the second transistor 13 and the fourth transistor 17 (connection point P4) of the magnetoresistance sense circuit 4, which is the only difference.

Under the above-mentioned bias voltage (V_{b-}, V_{b+}) conditions, the following formulas are established in a stationary status.

I_{B}=I₁+(ΔV_{b1})/R_{MR} (13)

I_{B}=I₂−(ΔV_{b1})/R_{MR} (14)

I₁=I₂₋I_{FB} (15)

Therefore

I_{FB}=2×(ΔV_{b1})/R_{MR} (16)

So I_{B} must be set under the following conditions according to formula (13).

I_{B}≧(ΔV_{b1})/R_{MR} (17)

When ΔV_{b1} is 0.3V and R_{MR} is 200Ω, I_{B} must be 1.5 mA or more according to formula (17). If I_{B} is set to 5 mA, I₁ becomes 3.5 mA according to formula (13), and I₂ becomes 6.5 mA according to formula (14). When ΔV_{b1} is 0.05V and R_{MR} is 400Ω, I₁ becomes 4.875 mA according to formula (13), and I₂ becomes 5.125 mA according to formula (14). This means that the difference between the maximum value and the minimum value of I₁ is 1.4 times, and the difference between the maximum value and the minimum value of I₂ is about 1.3 times, so a similar effect as the magnetic record reproducing devices according to the first and second embodiments can be obtained.

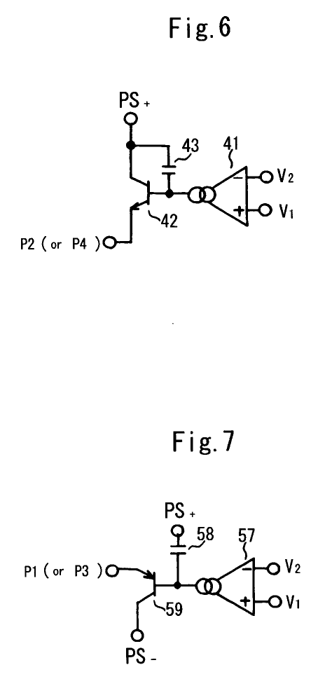

The feedback circuit 32 in the magnetic record reproducing devices in the second and third embodiments can be replaced with the feedback circuit shown in FIG. 6.

The feedback circuit in FIG. 6 is comprised of a gm amplifier 41 for inputting one of the differential voltage V₁ that is output by the magnetoresistance sense circuit 4 to a non-inversion input terminal and inputting V₂ to an inversion input terminal, and a capacitor 43 and a transistor 42 which are connected to the output of the gm amplifier 41. The emitter of the transistor 42 is connected to the above-mentioned connection point P2 or P4 in the magnetoresistance sense circuit 4. This magnetic record reproducing device is somewhat disadvantageous when the low cut-off frequency is minimized, but can be implemented by a semiconductor integrated circuit without using a bipolar and MOS mixed process, since the circuit can be constructed entirely by bipolar types.

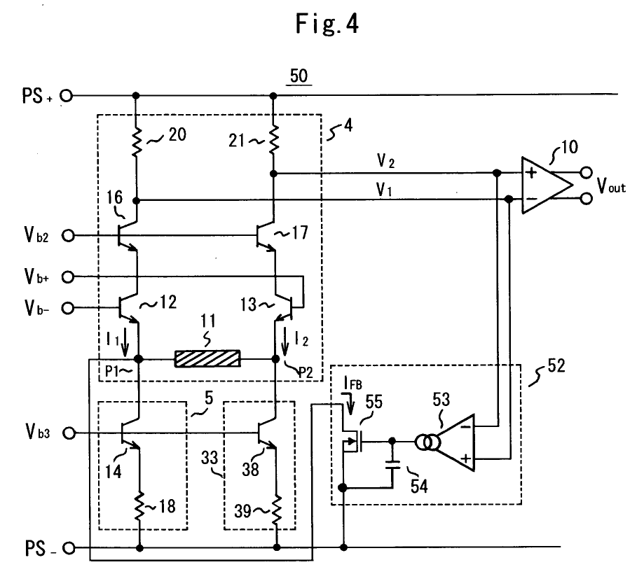

Now the magnetic record reproducing device according to the fourth embodiment of the present invention will be described with reference to FIG. 4. In this magnetic record reproducing device 50, the feedback circuit 32 of the magnetic record reproducing devices 30 and 31 in the second and third embodiments are replaced with the feedback circuit 52, and the output thereof is connected to the above-mentioned connection point P1 in the magnetoresistance sense circuit 4.

The feedback circuit 52 is comprised of a gm amplifier 53 for inputting one of the differential voltage V₁, which is output by the magnetoresistance sense circuit 4, to a non-inversion input terminal, and inputting V₂ to an inversion input terminal, and a capacitor 54 and an NMOS transistor 55 which are connected to the output of the gm amplifier 53. The drain of the NMOS transistor 55 is connected to the connection point P1 of the magnetoresistance sense circuit 4, and the feedback current (I_{FB}) flows through the NMOS transistor 55, by which the current (I₁) of the first transistor 12 is controlled.

Under the above-mentioned bias voltage (V₋, V_{b+}) conditions, the following formulas are established in a stationary status.

I_{B}=I₁+(ΔV_{b1})/R_{MR}−I_{FB} (18)

I_{B}=I₂−(ΔV_{b1})/R_{MR} (19)

I₁=I₂ (20)

Therefore

I_{FB}=2×(ΔV_{b1})/R_{MR} (21)

I₁=I₂=I_{B}+(ΔV_{b1})/R_{MR} (22)

When I_{B} is set to 5 mA, and when ΔV_{b1} is 0.3V and R_{MR} is 200Ω, I₁ and I₂ become 6.5 mA according to formula (22). When ΔV_{b1} is 0.05V, R_{MR} is 400Ω, I₁ and I₂ are 5.125 mA. This means that the difference between the maximum value and the minimum value of I₁ and I₂ is about 1.3 times, so a similar effect as the magnetic record reproducing device according to the first, second and third embodiments can be obtained.

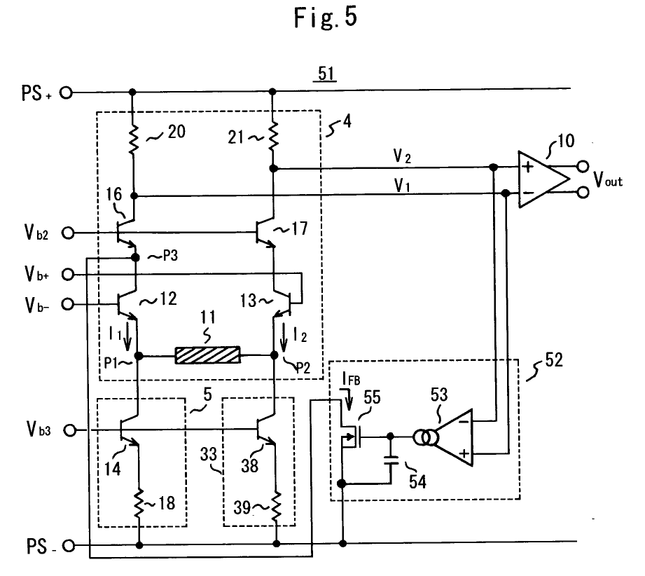

Now the magnetic record reproducing device according to the fifth embodiment of the present invention will be described with reference to FIG. 5. In this magnetic record reproducing device 51, the output of the feedback circuit 52 of the magnetic record reproducing device 50 according to the fourth embodiment is connected to the connection point (connection point P3) of the transistors 12 and 16 of the magnetic resistance sense circuit 4, which is the only difference.

Under the above-mentioned bias voltage (V_{b-}, V_{b+}) conditions, the following formulas are established in a stationary status.

I_{B}=I₁+(ΔV_{b1})/R_{MR} (23)

I_{B}=I₂−(ΔV_{b1})/R_{MR} (24)

I₁+I_{FB}=I₂ (25)

Therefore

I_{FB}=2×(ΔV_{b1})/R_{MR} (26)

When I_{B} is set to 5 mA, and when ΔV_{bi} is 0.3V and R_{MR} is 200Ω, I₁ becomes 3.5 mA according to formula (23), and I₂ becomes 6.5 mA according to formula (24). When ΔV_{b1} is 0.05V and R_{MR} is 400Ω, I₁ becomes 4.875 mA according to formula (23), and I₂ becomes 5.125 mA according to formula (24). This means that the difference between the maximum value and the minimum value of I₁ is 1.4 times, and the difference between the maximum value and the minimum value of I₂ is about 1.3 times, so a similar effect as the magnetic record reproducing devices according to the first, second, third and fourth embodiments can be obtained.

The feedback circuit 32 in the magnetic record reproducing device in the fourth and fifth embodiments can be replaced with the feedback circuit shown in FIG. 7.

The feedback circuit in FIG. 7 is comprised of a gm amplifier 57 for inputting one of the differential voltage V₁ that is output by the magnetoresistance sense circuit 4 to a non-inversion input terminal, and inputting V₂ to an inversion input terminal, and a capacitor 58 and a transistor 59 which are connected to the output of the gm amplifier 57. The emitter of the transistor 59 is connected to the above-mentioned connection point P1 or P3 in the magnetoresistance sense circuit 4.

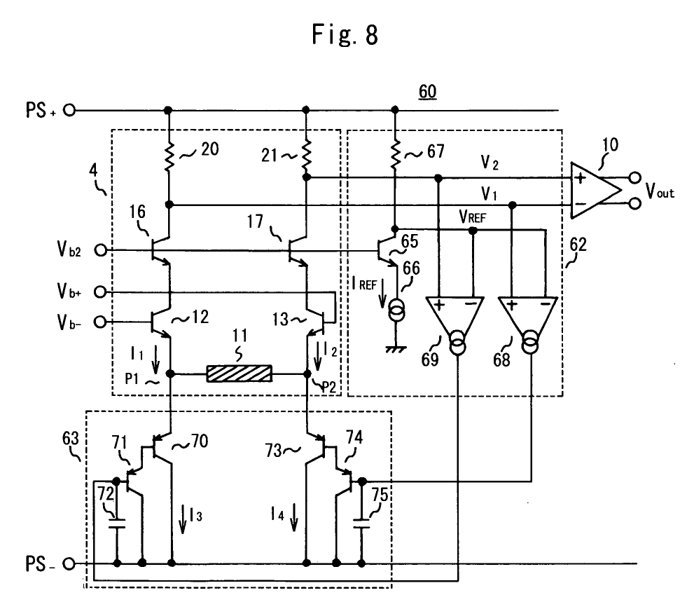

Now the magnetic record reproducing device according to the sixth embodiment of the present invention will be described with reference to FIG. 8. This magnetic record reproducing device 60 is comprised of a magnetoresistance sense circuit 4, a variable current circuit 63, an amplifier for driving 10, and a feedback circuit 62 for controlling current that flows through the variable current circuit 63. The magnetoresistance sense circuit 4 and the amplifier for driving 10 are the same as those in the first to fifth embodiments.

The variable current circuit 63 is comprised of a PNP type transistor 70 of which emitter is connected to the connection point P1 of the magnetoresistance sense circuit 4, and which flows lead-in current (I3), a PNP type transistor 71 of which emitter is connected to the base of the transistor 70, a capacitor 72 which is connected to the base of the transistor 71, a PNP type transistor 73 of which emitter is connected to the connection point P2 of the magnetoresistance sense circuit 4 and which flows the lead-in current (I4), a PNP type transistor 74 of which emitter is connected to the base of the transistor 73, and a capacitor 75 which is connected to the base of the transistor 74. The transistors 70 and 71 and the transistors 73 and 74 are Darlington-connected in order that the low cut-off frequency is minimized by decreasing the base current. In the present embodiment, a Darlington connection is used, but a Darlington connection may not be used depending on the desired characteristics.

The feedback circuit 62 is comprised of a constant current source 66 that flows the reference current (I_{REF}), a NPN type transistor 65 which shares the base voltage (V_{b2}) with the third and fourth transistors 16 and 17 of the magnetoresistance sense circuit 4, a resistor 67 which is connected to the collector of the transistor 65 and has a resistance value the same as the load resistances 20 and 21 of the magnetoresistance sense circuit 4, and gm amplifiers 68 and 69 for inputting each of the differential voltage (V₁, V₂), which the magnetoresistance sense circuit 4 outputs, to the non-inversion input terminal respectively, and inputting the reference voltage (V_{REF}), which is the voltage of the connection point of the transistor 65 and the resistor 67, to the inversion input terminal. In this feedback circuit 62, the gm amplifiers 68 and 69 compare the differential voltage (V₁, V₂), which is output from the magnetoresistance sense circuit 4, with the reference voltage (V_{REF}), and the output current thereof controls the current of the variable current circuit 63 by controlling the voltage of the capacitors 75 and 72 of the variable current circuit 63 respectively.

This magnetic record reproducing device 60 operates as follows. At first, in a stationary status where the magnetic field from the magnetic recording medium does not change, V₁, V₂ and V_{REF} are all equal, and the gm amplifiers 68 and 69 do not draw or supply the stored charges of the capacitors 75 and 72 of the variable current circuit 63, keeping these voltages constant.

When the magnetic field from the magnetic recording medium changes, the current (I₁) that flows through the first transistor 12 and the current (I₂) that flows through the second transistor 13 temporarily changes in the opposite direction. As a result, the differential voltage (V₁, V₂) which is output from the magnetoresistance sense circuit 4 departs from the reference voltage (V_{REF}) once, but I₁ and I₂ eventually become equal by the function of the feedback circuit 62 and the variable current circuit 63. During this transition period, the amplifier for driving 10 outputs signals according to the changes of the magnetic field.

Under the above-mentioned bias voltage (V_{b-}, V_{b+}conditions, the following formulas are established in a stationary status.

I₃=I₁+(ΔV_{b1})/R_{MR} (27)

I₄=I₂+(ΔV_{b1})/R_{MR} (28)

I₁=I₂=I_{REF} (29)

Therefore

I₃=I_{REF}+(ΔV_{b1})/R_{MR} (30)

I₄=I_{REF}−(ΔV_{b1})/R_{MR} (31)

So I_{B} must be set under the following conditions.

I_{REF}≧(ΔV_{b1})/R_{MR} (32)

When ΔV_{b1} is 0.3V and R_{MR} is 200Ω, I_{REF} can be arbitrarily set only if the value is 1.5 mA or higher according to formula (32).

In a stationary status, formula (29) is established, and I₁ and I₂ are not influenced by ΔV_{b1} and R_{MR} at all and not fluctuate, so an even better effect than the magnetic record reproducing device according to the first to fifth embodiments can be obtained.

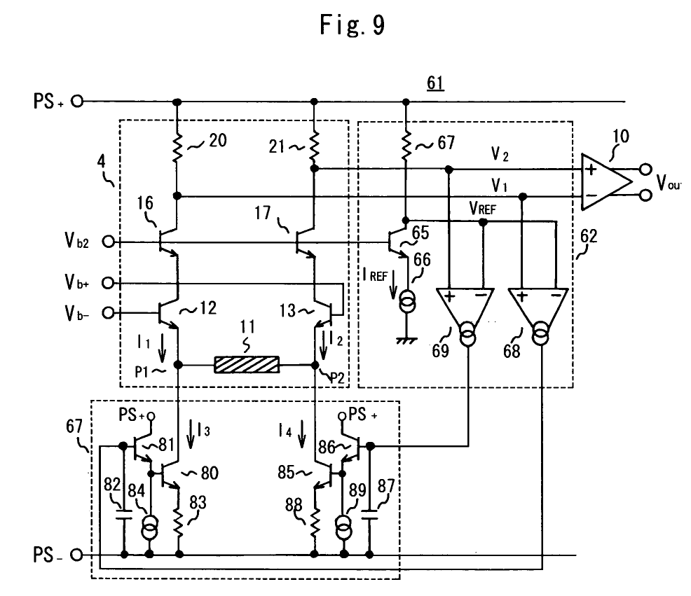

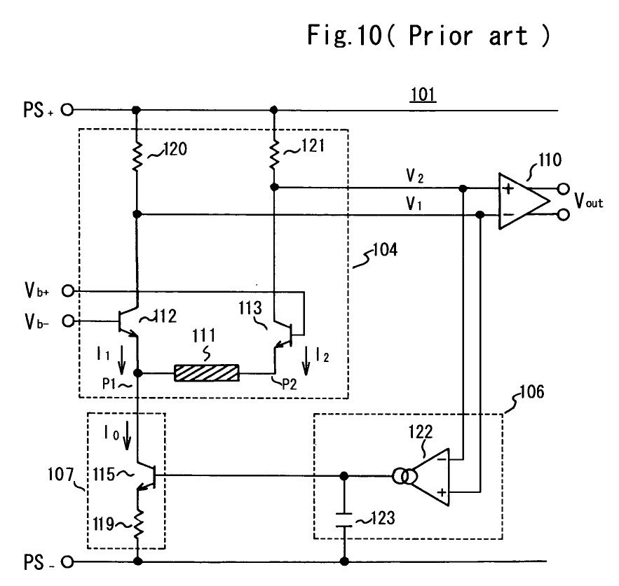

Now the magnetic record reproducing device according to the seventh embodiment of the present invention will be described with reference to FIG. 9. In this magnetic record reproducing device 61, the variable current circuit 63 of the magnetic record reproducing device 60 according to the sixth embodiment is replaced with the variable current circuit 67.

The variable current circuit 67 is comprised of a NPN type transistor 80 of which collector is connected to the connection point P1 of the magnetoresistance sense circuit 4 and which flows lead-in current (I3), a resistor 83 which is connected to the emitter of the transistor 80, an NPN type transistor 81 of which emitter is connected to the base of the transistor 80, a constant current source 84 which is connected to this connection point, a capacitor 82 which is connected to the base of the transistor 81, an NPN type transistor 85 of which collector is connected to the connection point P2 of the magnetoresistance sense circuit 4 and which flows the lead-in current (I4), a resistor 88 which is connected to the emitter of the transistor 85, an NPN type transistor 86 of which emitter is connected to the base of the transistor 85, a constant current source 89 which is connected to this connection point, and a capacitor 87 which is connected to the base of the transistor 86. The output current of the gm amplifiers 68 and 69 of the feedback circuit 62 controls the current of the variable current circuit 67 by controlling the voltage of the capacitors 82 and 87 of the variable current circuit 67 respectively.

Under the above-mentioned bias voltage (V_{b-}, V_{b+}) conditions, the formulas the same as that described in the sixth embodiment are established. Therefore a superb effect similar to the magnetic record reproducing device 60 according to the sixth embodiment can be obtained.

In the first to seventh embodiments, a dual-power supply device where the power supply voltage (PS₋) at the negative side exists was described, but in the case of a single power supply device, the power supply voltage (PS₋) at the negative side is the ground potential.

The present embodiment is not limited to the above mentioned embodiment, but the design can be changed in various ways within the scope of the particulars stated in the Claims. For instance, in the first to seventh embodiments, mainly bipolar transistors are used for transistors, but needless to say, these transistors can be replaced with MOS transistors. Also a circuit using a gm amplifier was described as the feedback circuit, but a different circuit equivalent to this circuit can be used.

What is claimed is:

1. A magnetic record reproducing device for detecting the change of a resistance value of a magnetoresistive head, comprising:
a magnetoresistance sense circuit, that further comprises a first transistor for inputting a first bias voltage, a second transistor which is connected in parallel with the first transistor and inputs a second bias voltage higher than the first bias voltage, and a magnetoresistive head of which both ends are connected to the first and second transistors, and that converts the current of the first and second transistors, which changes according to the change of the resistance value of the magnetoresistive head, and outputs the differential voltage as the converted current;
a constant current circuit that is connected to a connection point of said first transistor and said magnetoresistive head;
a variable current circuit that is connected to a connection point of said second transistor and said magnetoresistive head; and
a feedback circuit for controlling the current of said variable current circuit according to the differential voltage that is output from said magnetoresistance sense circuit.

2. The magnetic record reproducing device according to claim 1, wherein the current of said first and second transistors is converted via a third and fourth transistors for eliminating the influence of the parasitic capacitance of said first and second transistors, and said differential voltage is output.

3. The magnetic record reproducing device according to claim 1, wherein said feedback circuit further comprises a gm amplifier for inputting said differential voltage and a capacitor for storing electric charges of the current output by said gm amplifier and for controlling the current of said variable current circuit by said electric charges.

4. A magnetic record reproducing device for detecting the change of a resistance value of a magnetoresistive head, comprising:
a magnetoresistance sense circuit that further comprises a first transistor for inputting a first bias voltage, a second transistor which is connected in parallel with the first transistor and inputs a second bias voltage higher than the first bias voltage, and a magnetoresistive head of which both ends are connected to the first and second transistors, and that converts the current of the first and second transistors, which changes according to the change of the resistance value of the magnetoresistive head, and outputs the differential voltage as the converted current;
first and second constant current circuits that are connected to the connection points of said first and second transistors and said magnetoresistive head; and
a feedback circuit for controlling the current of said first or second transistor according to the differential voltage that is output from said magnetoresistance sense circuit.

5. The magnetic record reproducing device according to claim 4, wherein the current of said first and second transistors is converted via a third and fourth transistors for eliminating the influence of the parasitic capacitance of said first and second transistors, and said differential voltage is output.

6. The magnetic record reproducing device according to claim 4, wherein said feedback circuit further comprises a MOS type transistor that is connected to the connection point of said second transistor and said magnetoresistive head, and the current of said second transistor is controlled by the current of said MOS type transistor.

7. The magnetic record reproducing device according to claim 6, wherein said feedback circuit further comprises a gm amplifier for inputting said differential voltage and a capacitor for storing electric charges of the current output by said gm amplifier and for controlling the current of said MOS type transistor by said electric charges.

8. The magnetic record reproducing device according to claim 5, wherein said feedback circuit further comprises a MOS type transistor that is connected to the connection point of said second transistor and said fourth transistor, and the current of said second transistor is controlled by the current of said MOS type transistor.

9. The magnetic record reproducing device according to claim 8, wherein said feedback circuit further comprises a gm amplifier for inputting said differential voltage and a capacitor for storing electric charges of the current output by said gm amplifier and for controlling the current of said MOS type transistor by said electric charges.

10. The magnetic record reproducing device according to claim 4, wherein said feedback circuit further comprises a MOS type transistor that is connected to the connection point of said first transistor and said magnetoresistive head, and the current of said first transistor is controlled by the current of said MOS type transistor.

11. The magnetic record reproducing device according to claim 10, wherein said feedback circuit further comprises a gm amplifier for inputting said differential voltage and a capacitor for storing electric charges of the current output by said gm amplifier and for controlling the current of said MOS type transistor by said electric charges.

12. The magnetic record reproducing device according to claim 5, wherein said feedback circuit further comprises a MOS type transistor that is connected to the connection point of said first transistor and said third transistor, and the current of said second transistor is controlled by the current of said MOS type transistor.

13. The magnetic record reproducing device according to claim 12, wherein said feedback circuit further comprises a gm amplifier for inputting said differential voltage and a capacitor for storing electric charges of the current output by said gm amplifier and for controlling the current of said MOS type transistor by said electric charges.

14. A magnetic record reproducing device for detecting the change of a resistance value of a magnetoresistive head, comprising:
a magnetoresistance sense circuit, that further comprises a first transistor for inputting a first bias voltage, a second transistor which is connected in parallel with the first transistor and inputs a second bias voltage higher than the first bias voltage, and a magnetoresistive head of which both ends are connected to the first and second transistors, and that converts the current of the first and second transistors, which changes according to the change of the resistance value of the magnetoresistive head, and outputs the differential voltage as the converted current;
a variable current circuit that is connected to the connection points of said first and second transistors and said magnetoresistive head; and
a feedback circuit for controlling the current of said variable current circuit by comparing the differential voltage that is output from said magnetoresistance sense circuit with a reference voltage.

15. The magnetic record reproducing device according to claim 14, wherein the current of said first and second transistors is converted via a third and fourth transistors for eliminating the influence of the parasitic capacitance of said first and second transistors, and said differential voltage is output.

16. The magnetic record reproducing device according to claim 14, wherein said feedback circuit further comprises two gm amplifiers for inputting each of said differential voltage and said reference voltage, and said variable current circuit further comprises two capacitors for storing electric charges of the current output by said gm amplifiers and for controlling the current flowing at the connection points of said first and second transistors and said magnetoresistive head.
